(19) United States
(12) Patent Application Publication
(10) Pub. No.: US 2025/0365724 A1
(43) Pub. Date: Nov. 27, 2025

(54) SUPPLEMENTARY PHYSICAL UPLINK CONTROL CHANNEL

(71) Applicant: QUALCOMM Incorporated, San Diego, CA (US)

(72) Inventors: Kangqi LIU, San Diego, CA (US); Gabi SARKIS, San Diego, CA (US); Wei YANG, San Diego, CA (US); Weimin DUAN, San Diego, CA (US); Neelakanta Venkata Seshachalam CHIMMAPUDI, San Diego, CA (US)

(21) Appl. No.: 18/673,132

(22) Filed: May 23, 2024

(51) Int. Cl. H04W 72/1268; H04W 72/02; H04W 72/21

(52) U.S. Cl. CPC H04W 72/1268; H04W 72/02; H04W 72/21

(57) ABSTRACT

Certain aspects of the present disclosure provide techniques for supplementary physical uplink control channel (PUCCH) configuration. An example method, performed at a user equipment (UE), generally includes receiving configuration information indicating first physical uplink control channel (PUCCH) resources for primary PUCCH transmissions and second PUCCH resources for supplementary PUCCH transmissions associated with the primary PUCCH transmissions, transmitting at least one primary PUCCH on the first PUCCH resources, and transmitting at least one supplementary PUCCH on the second PUCCH resources.

### FIELD OF THE DISCLOSURE

Aspects of the present disclosure relate to wireless communications, and more particularly, to techniques for a supplementary physical uplink control channel (PUCCH) configuration.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving configuration information indicating first physical uplink control channel (PUCCH) resources for primary PUCCH transmissions and second PUCCH resources for supplementary PUCCH transmissions associated with the primary PUCCH transmissions; transmitting at least one primary PUCCH on the first PUCCH resources; and transmitting at least one supplementary PUCCH on the second PUCCH resources.

Another aspect provides a method for wireless communication at a network entity. The method includes transmitting configuration information indicating first physical uplink control channel (PUCCH) resources for primary PUCCH transmissions and second PUCCH resources for supplementary PUCCH transmissions associated with the primary PUCCH transmissions; receiving at least one primary PUCCH on the first PUCCH resources; and receiving at least one supplementary PUCCH on the second PUCCH resources.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a diagram illustrating an example of a physical uplink control channel (PUCCH) reliability issue that may cause reduced downlink throughput and resource efficiency.

FIG. 6 depicts an example supplementary physical uplink control channel (PUCCH) configuration, in accordance with aspects of the present disclosure.

FIGS. 7A and 7B depict examples of how an uplink control information (UCI) payload may be transmitted in a main/primary PUCCH and a supplementary PUCCH, in accordance with aspects of the present disclosure.

FIG. 8 depicts a call flow diagram, in accordance with aspects of the present disclosure.

FIG. 9 depicts a method for wireless communications.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for supplementary physical uplink control channel (PUCCH) configuration.

The Physical Downlink Shared Channel (PDSCH) discard rate is a metric used in wireless communication systems to measure the percentage of data blocks transmitted over the downlink shared channel that are discarded (e.g., due to various factors such as channel conditions, interference) before reaching the intended recipient. The discard rate of PDSCH can be calculated by dividing the number of discarded data blocks by the total number of transmitted data blocks, expressed as a percentage.

PUCCH is primarily responsible for carrying uplink control information (UCI), including acknowledgments (ACKs) and negative acknowledgments (NACKs), from the user equipment (UE) to the network (e.g., gNB). When a UE receives data on a Physical Downlink Shared Channel (PDSCH), it sends an acknowledgment (ACK) to the network on a PUCCH to confirm successful reception. Conversely, if the data is not received correctly, it sends a negative acknowledgment (NACK).

However, if the PUCCH channel suffers from interference, fading, or other impairments, it may lead to errors in ACK reception at the network, resulting in ACK errors. For example, the network may misinterpret a positive acknowledgment (ACK) as a negative acknowledgment (NACK) or may not receive an ACK transmission and interpret that as a discontinuous transmission (DTX). In either of such scenarios, ACK errors caused by PUCCH impairments can trigger (unnecessary) retransmissions of data blocks on the PDSCH by the network, increasing the PDSCH discard rate. An increased PDSCH discard rate results in decreased overall system downlink throughput and overall resource efficiency.

PUCCH in lower bands (e.g., 700 MHz FDD) is associated with a better link budget than PUCCH in higher bands (e.g., 2.6 GHz TDD). The PDSCH discard rate for PUCCH in higher bands increases (e.g., starting from RSRP=−106 dBm) as the uplink power becomes limited. In some cases, the PDSCH discarding rate could reach 15% or more, meaning that 15% of the downlink resources are wasted for unnecessary PDSCH retransmission. However, the PDSCH discarding rate, caused by the ACK error, is a UE-measured performance metric that the network has no knowledge about. Moreover, in advanced wireless systems (e.g., 5G NR), there is generally no PUCCH retransmission. Thus, when an ACK error occurs, the network will just retransmit the PDSCH (sacrificing downlink resource efficiency), unaware of the ACK error. When a NACK error occurs, the radio link control (RLC) acknowledge mode (AM) will trigger automatic repeat request (ARQ) procedures, increasing latency due to the unnecessary retransmission of data already successfully received at the UE, which also prevents new data from being transmitted.

Aspects of the present disclosure provide techniques for configuration and use of UE-initiated supplementary PUCCH. For example, aspects of the present disclosure enable configuration of supplementary PUCCH resources and an association between a main/primary PUCCH resource and a supplementary PUCCH resource, triggering of UE-initiated PUCCH transmission in the supplementary PUCCH resource, activation and deactivation of supplementary PUCCH transmission, and defines network behavior and multiplexing in the supplementary PUCCH resource. Utilization of the techniques disclosed herein may enhance PUCCH reliability, decreasing the PDSCH discard rate, and resulting in improved downlink throughput and resource efficiency.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

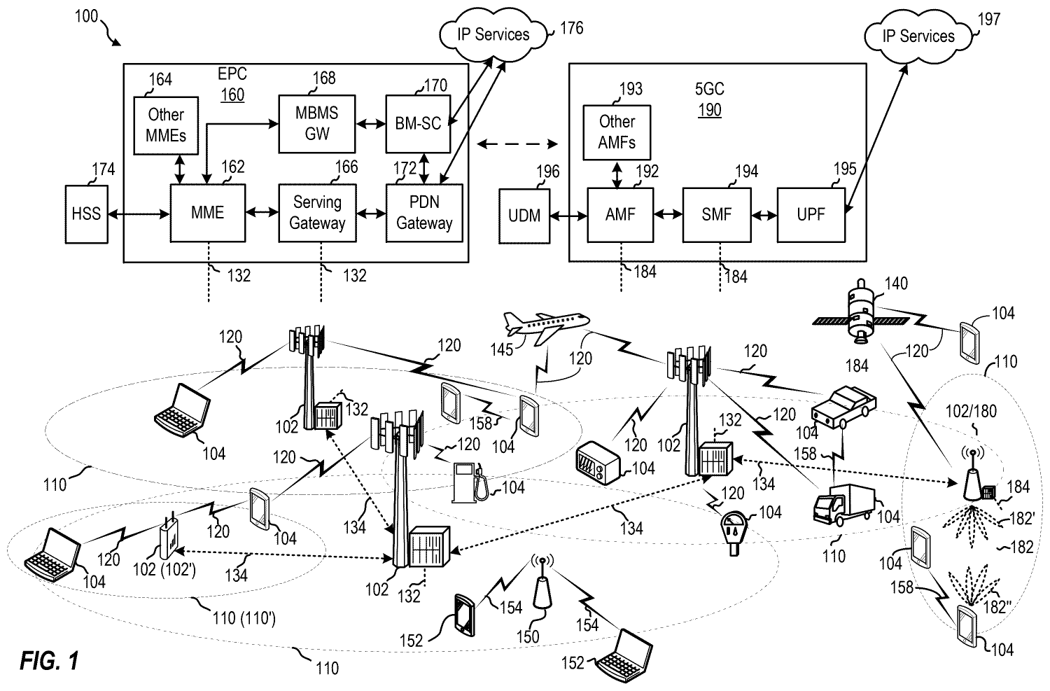

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

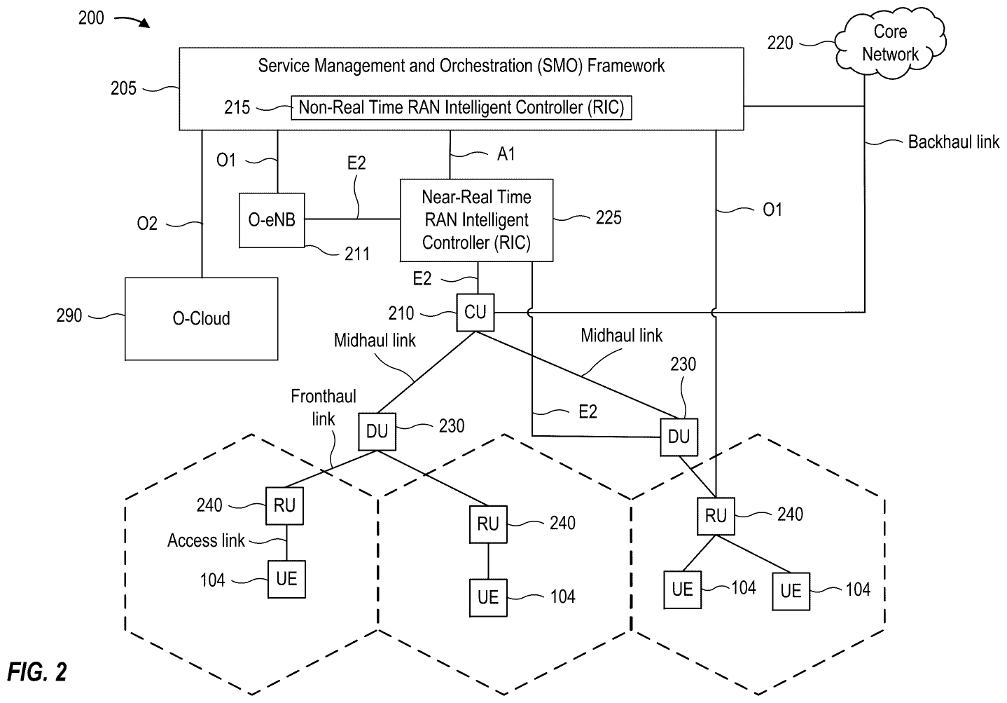

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

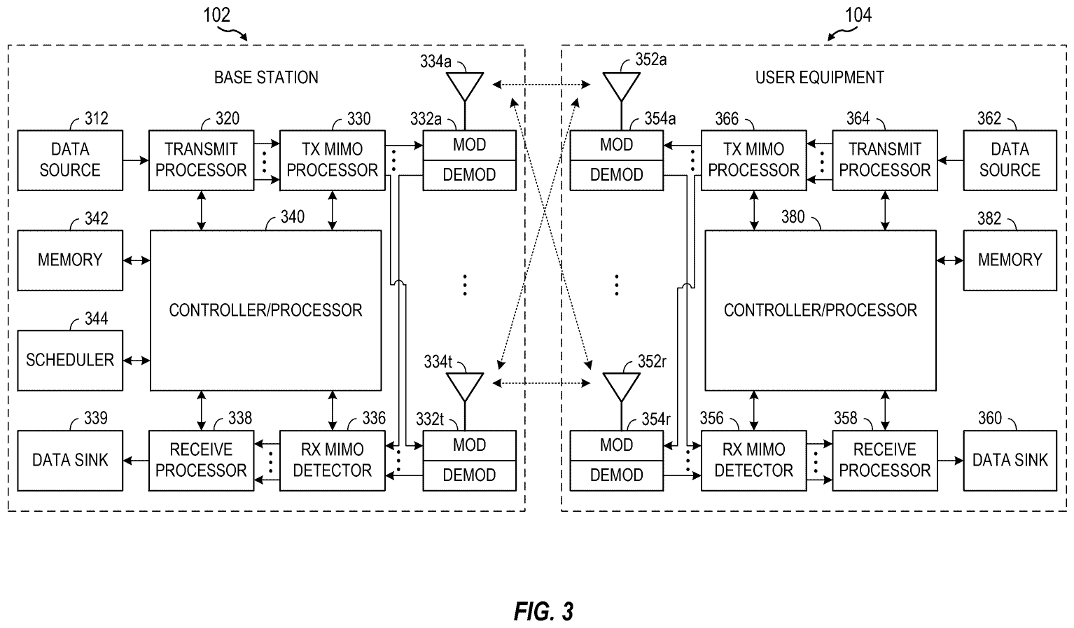

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

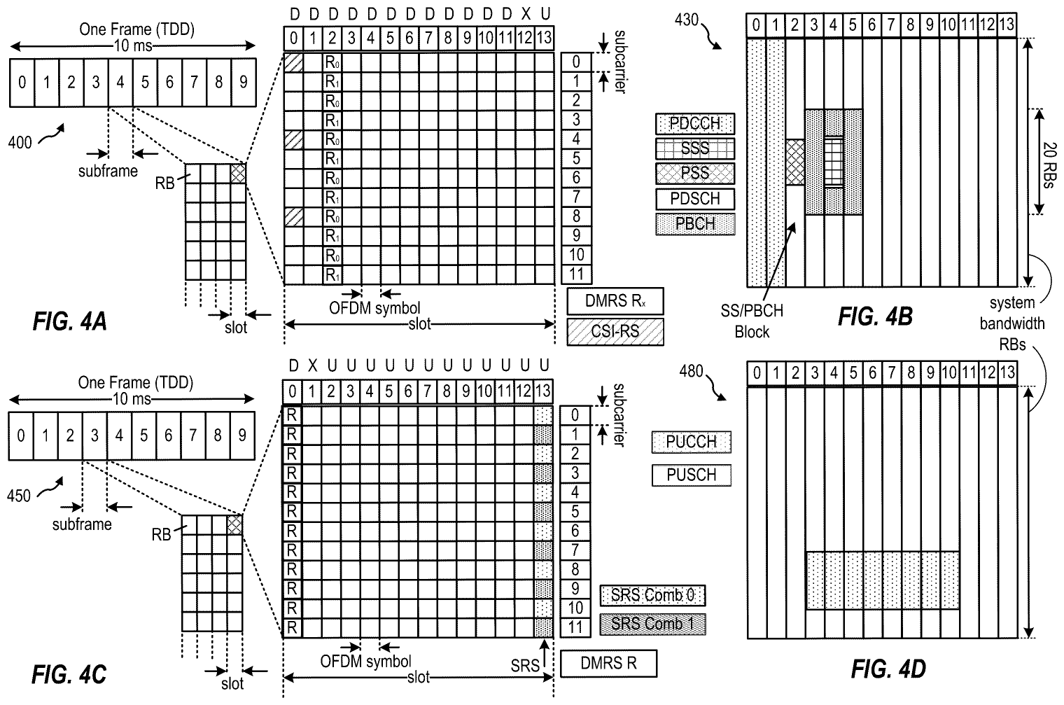

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Supplementary PUCCH Configuration

As noted above, if a PUCCH channel suffers from interference, fading, or other impairments, it may lead to errors in ACK reception at the network, resulting in ACK errors. In such scenarios, ACK errors caused by PUCCH impairments can trigger (unnecessary) retransmissions of data blocks on the PDSCH by the network, increasing the PDSCH discard rate. An increased PDSCH discard rate results in decreased overall system downlink throughput and overall resource efficiency.

However, the PDSCH discarding rate, caused by the ACK error, is a UE-measured performance metric that the network typically has no knowledge about. In other words, the network is not aware the UE has actually received the data that it transmitted due to the error in processing the PUCCH carrying the ACK. Moreover, in advanced wireless systems (e.g., 5G NR), there is generally no PUCCH retransmission. Thus, when an ACK error occurs, the network will just retransmit the PDSCH (sacrificing downlink resource efficiency), unaware of the ACK error. When a NACK error occurs, the radio link control (RLC) acknowledge mode (AM) will trigger automatic repeat request (ARQ) procedures, increasing latency.

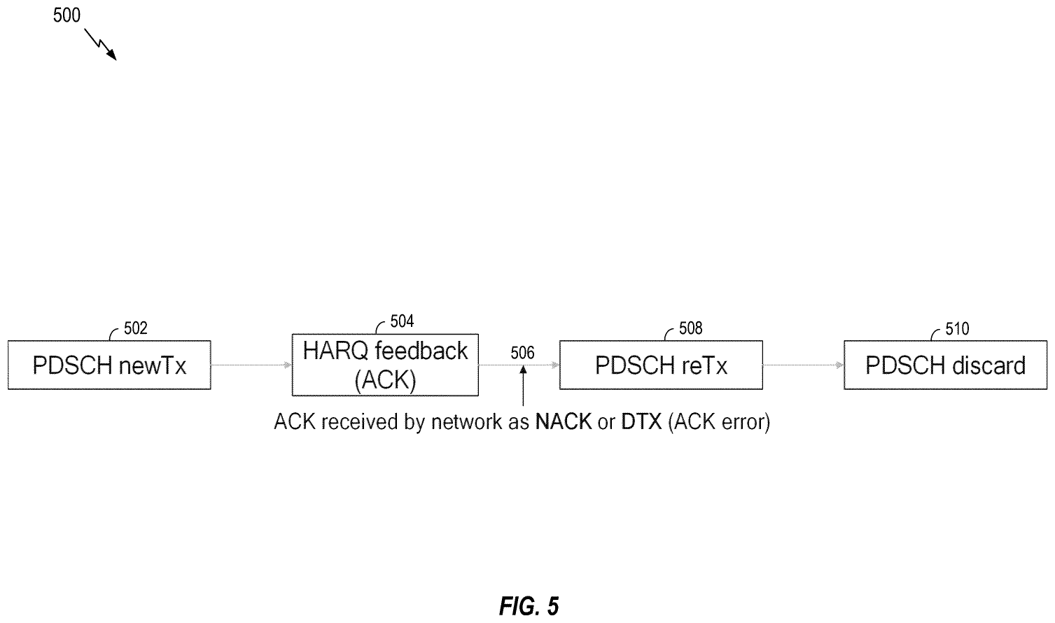

This issue may be understood with reference to FIG. 5, which depicts a diagram 500 illustrating an example sequence of events triggered by a physical uplink control channel (PUCCH) reliability issue that may cause reduced downlink throughput and resource efficiency.

As illustrated at 502, the network may transmit a new (e.g., not a retransmission) PDSCH transmission. As illustrated at 504, the UE may transmit HARQ feedback (e.g., ACK) to the network (on a PUCCH) after receiving the PDSCH transmission.

As illustrated at 506, however (e.g., due to impairments of the PUCCH channel), the ACK may be received by the network as a NACK or not received at all and declared a discontinuous transmission (DTX), resulting in an ACK error. As illustrated at 508, the ACK error may trigger (an unnecessary) retransmission of the PDSCH by the network, which will be discarded (as illustrated at 510), increasing the PDSCH discard rate and resulting in decreased overall system downlink throughput and overall resource efficiency.

Aspects of the present disclosure provide techniques for configuration and use of UE-initiated supplementary PUCCH. For example, aspects of the present disclosure enable configuration of supplementary PUCCH resources and an association between a main/primary PUCCH resource and a supplementary PUCCH resource, triggering of UE-initiated PUCCH transmission in the supplementary PUCCH resource, activation and deactivation of supplementary PUCCH transmission, and defines network behavior and multiplexing in the supplementary PUCCH resource.

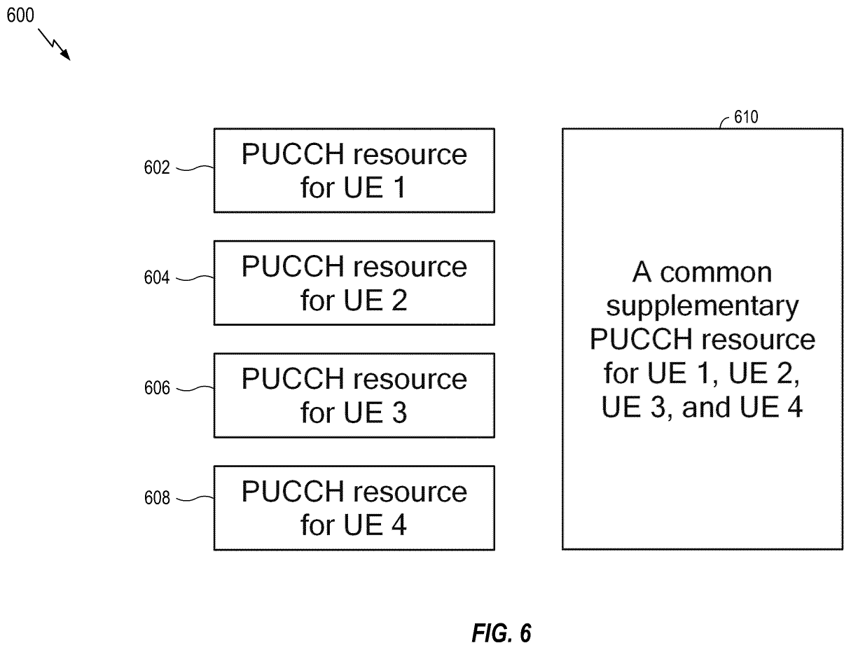

FIG. 6 depicts an example supplementary physical uplink control channel (PUCCH) configuration 600, in accordance with aspects of the present disclosure.

As illustrated at 602, 604, 606, and 608, one or more UEs (e.g., each of UEs 1, 2, 3, 4) may be configured with a main/primary PUCCH resource for PUCCH transmission.

As illustrated at 610, each UE may be configured with a supplementary PUCCH resource for PUCCH transmission, according to aspects of the present disclosure. In some aspects, as illustrated at 610, the supplementary PUCCH resource may be configured for one or more UEs (e.g., a group-common supplementary PUCCH resource). In some aspects, however, each UE may be configured with its own supplementary PUCCH resource.

In some aspects, the PUCCH format (e.g., PUCCH format 0, PUCCH format 1, PUCCH format 2, PUCCH format 3, PUCCH format 4, etc.) that is (configured and) used for transmission in the main/primary PUCCH resource may be different than (e.g., or may be the same as) a PUCCH format that is (configured and) used for transmission in the supplementary PUCCH resource.

Similarly, in some aspects, the PUCCH transmission scheme that is used for transmission in the main PUCCH resource may be the same or different from the PUCCH transmission scheme that is used for transmission in the supplementary PUCCH resource. PUCCH transmission schemes may encompass factors such as what PUCCH format is used and whether a PUCCH transmission is coherent (e.g., DMRS-based) or non-coherent (e.g., sequence-based). In some cases, a coherent PUCCH transmission scheme may be used for transmission in the main PUCCH resources while a non-coherent PUCCH transmission scheme may be used for supplementary PUCCH resources. In other cases, a non-coherent PUCCH transmission scheme may be used for transmission in the main PUCCH resources while a coherent PUCCH transmission scheme may be used for supplementary PUCCH resources.

As noted above, there may be an association between the main/primary PUCCH resource and the supplementary PUCCH resource. In some aspects, the supplementary PUCCH resource may be configured and indicated as being associated with the main PUCCH resource in a single information element (IE). In some aspects, the supplementary PUCCH resource and the main PUCCH resource may be configured in a single IE.

In some aspects, for example, the IE may configure both the main/primary PUCCH resource and the supplementary PUCCH resource semi-persistently. In such cases, an update/change of either of the main PUCCH resource or the supplementary PUCCH resource may be performed by RRC reconfiguration.

In some aspects, the IE may configure multiple sets of the main PUCCH resource and the supplementary PUCCH resource. For example, the IE may configure a set of (main PUCCH resource, supplementary PUCCH resource) pairs to select from. Alternatively, the IE may configure a first set of main PUCCH resources and a second set of supplementary PUCCH resources to select from. In some aspects, the network may then use MAC-CE/DCI signaling to dynamically select a set of main/supplementary PUCCH resources for PUCCH transmission.

In some aspects, the network may use MAC-CE/DCI signaling to dynamically indicate (e.g., explicitly) the main PUCCH resource and supplementary PUCCH resource.

In some aspects, the supplementary PUCCH resource may be configured separately from the main PUCCH resource, but with an indication of its associated main PUCCH resource. For example, the supplementary PUCCH resource configuration may include at least an indication of its associated main PUCCH resource. In some aspects, the main PUCCH resource may reuse existing (e.g., legacy) configurations without modification.

In some aspects, the UE may determine whether to transmit PUCCH in the supplementary PUCCH resource. The UE's determination (e.g., and the factors considered in the determination) to transmit in the supplementary PUCCH resource or not may be up to UE implementation. For example, the UE may consider ACK errors, an increased PDSCH discard rate, NACK errors, an increased RLC AM ARQ rate, etc. (e.g., which may be compared to one or more thresholds) when determining whether to transmit PUCCH in the supplementary PUCCH resource.

In some aspects, the UE may consider UCI type when determining whether to transmit PUCCH in the supplementary PUCCH resource. For example, the UE may only transmit the supplementary PUCCH when the UCI includes HARQ-ACK.

In some aspects, for example, the supplementary PUCCH transmission may only be triggered for a transmission which does (e.g., or does not) include a cyclic redundancy check (CRC). For example, if the UCI only includes CSI, the UE may determine to not send the supplementary PUCCH (e.g., for UE power savings), since the network (e.g., a gNB) may be able to detect CSI failure based on CRC. If a PUCCH has a CRC, then the network may be aware of a failure event, and the network may adjust the PUCCH resource based on the CRC check.

In some aspects, the UE may decide whether to transmit the supplementary PUCCH based on the payload size of the PUCCH. For example, there may be 10 dB differences between the receive power required to decode a 1-bit PUCCH compared to a 10-bit PUCCH. A metric that may be used may be based on power headroom (PHR). For example, if the UE is transmitting PUCCH at a negative PHR (indicating the UE may be transmitting at a maximum transmission power level due to poor channel conditions or UE location), then the UE may enable supplementary PUCCH transmission. Conversely, if the UE is transmitting PUCCH at a positive PHR (indicating better channel conditions less likely to result in ACK errors), the UE may decide to not transmit supplementary PUCCH.

Since the UE knows the payload size of each PUCCH transmission, and since the UE knows whether a redundant PDSCH transmission is associated with a 1-bit PUCCH transmission or a multi-bit PUCCH, the UE may decide whether/when to transmit the supplementary PUCCH based on the payload of each PUCCH transmission. For example, in some cases, the UE may decide to only transmit a supplementary PUCCH for a multi-bit PUCCH payload, and may decide not to transmit a supplementary PUCCH for single-bit PUCCH payload (or vice versa).

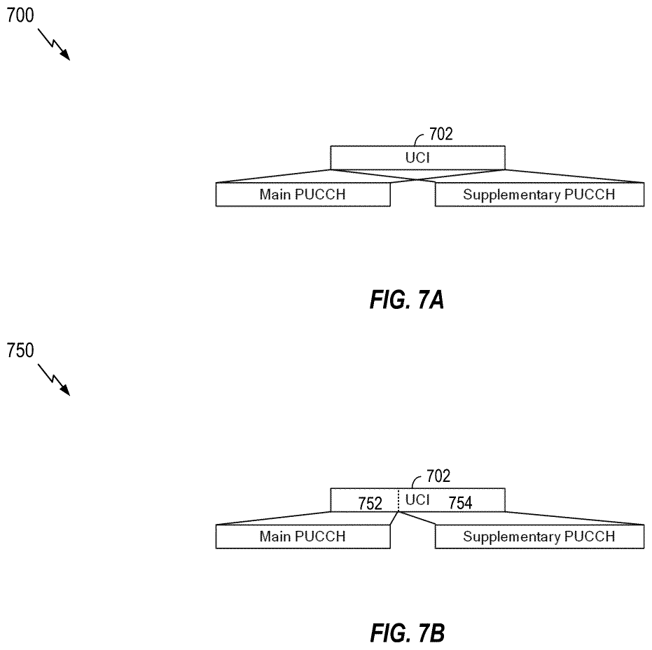

FIGS. 7A and 7B depict examples of how an uplink control information (UCI) payload may be transmitted in a main/primary PUCCH and a supplementary PUCCH, in accordance with aspects of the present disclosure.

FIG. 7A depicts an example 700 of how the UE may transmit the same UCI payload 702 in both the main PUCCH resource and the supplementary PUCCH resource (with repetition). As illustrated, for example, a UCI payload may be transmitted in the main PUCCH resource, and retransmitted (e.g., repetition) in the supplementary PUCCH resource. In some aspects, the retransmission/repetition may use a different PUCCH format.

FIG. 7B depicts an example 750 of how the UE may partition the UCI payload 702 into two parts, where the first part 752 is transmitted in the main PUCCH resource, and the second part 754 is transmitted in the supplementary PUCCH resource. As illustrated, for example, the UE may transmit a first portion of a UCI payload in the main PUCCH resource and a second portion of the UCI payload in the supplementary PUCCH resource.

In some aspects, the UE may explicitly indicate in the main PUCCH transmission that there is (e.g., or that there will be) a supplementary PUCCH transmitted in the supplementary PUCCH resource.

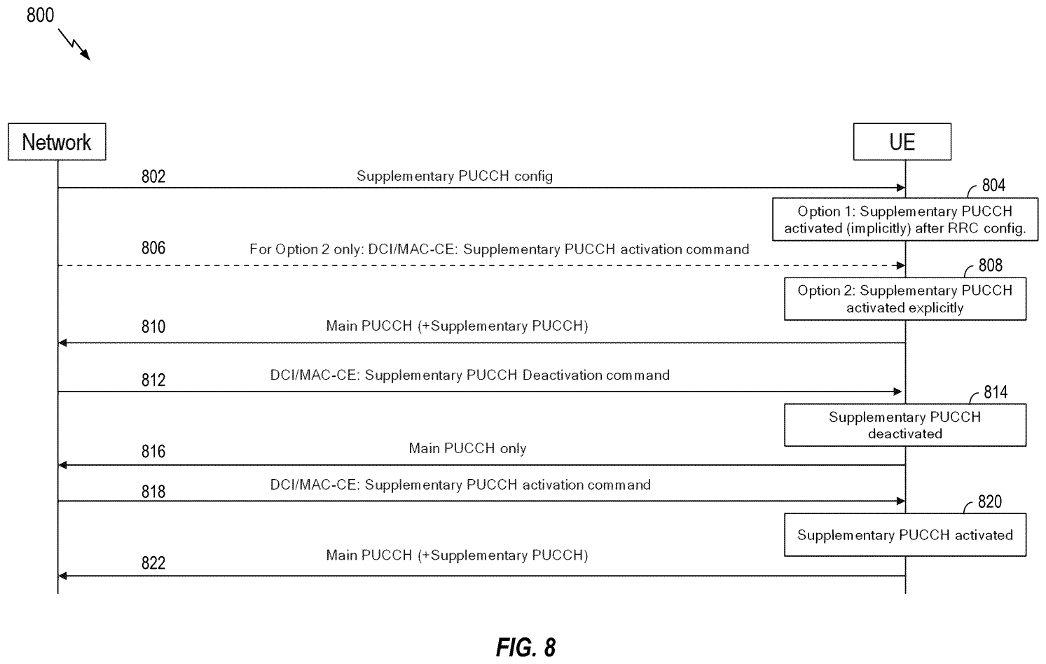

FIG. 8 depicts a call flow diagram 800, in accordance with aspects of the present disclosure. In some aspects, the UE shown in FIG. 8 may be an example of the UE 104 depicted and described with respect to FIGS. 1 and 3. Similarly, the network entity shown in FIG. 8 may be an example of the BS 102 (e.g., a gNB) depicted and described with respect to FIGS. 1 and 3 or a disaggregated base station depicted and described with respect to FIG. 2.

As illustrated at 802, the network may transmit (e.g., via RRC signaling) a supplementary PUCCH configuration, configuring the UE with resources for supplementary PUCCH transmission. As illustrated at 804, according to a first option (Option 1), supplementary PUCCH transmission may be implicitly activated after receiving the supplementary PUCCH configuration.

As illustrated at 806, according to a second option (Option 2, e.g., if the supplementary PUCCH configuration does not implicitly activate supplementary PUCCH transmission), the network may transmit a supplementary PUCCH activation command (e.g., via DCI and/or MAC-CE signaling). As illustrated at 808, the supplementary PUCCH activation command may explicitly activate supplementary PUCCH transmission.

As illustrated at 810, the UE may transmit a main/primary PUCCH (e.g., in first resources) and a supplementary PUCCH (e.g., in second resources), in accordance with the supplementary PUCCH configuration.

As illustrated at 812, the network may transmit a deactivation command, deactivating supplementary PUCCH transmission (as shown at 814). As illustrated at 816, the UE may transmit a main/primary PUCCH only, refraining from transmitting the supplementary PUCCH based on the deactivation.

As illustrated at 818, the network may transmit an activation command (e.g., via DCI and/or MAC-CE signaling), activating supplementary PUCCH transmission (as shown at 820). As illustrated at 822, the UE may transmit a main/primary PUCCH (e.g., in first resources) and a supplementary PUCCH (e.g., in second resources), in accordance with the activation command and the supplementary PUCCH configuration.

In some aspects, the network may be implicitly indicated of a lack of PUCCH reliability when the UE uses the supplementary PUCCH resource for PUCCH transmission. In other words, supplementary PUCCH transmission may implicitly inform the network of poor PUCCH reliability and/or PUCCH impairments.

In some aspects, when the network receives a certain quantity (X) of (e.g., consecutive) PUCCH transmissions in the supplementary PUCCH resource, where X is greater than a threshold (e.g., which may be defined by wireless communications standards), the network may (re) configure the UE to use a PUCCH format with a higher reliability. In such cases, the network may prohibit certain resource-efficient PUCCH formats with lower reliability.

In some aspects (e.g., up to network implementation), in the case where the supplementary PUCCH resource is used to transmit a repetition of the same PUCCH payload that was transmitted in the main/primary PUCCH resource, the network may only detect/monitor/process/decode the supplementary PUCCH resource if it detects a DTX in the main PUCCH resource.

In some aspects, the network may schedule multiple UEs to use (e.g., or to be able to use) a supplementary PUCCH resource simultaneously. While there is a risk of collision with this approach, this approach may still be acceptable since the supplementary PUCCH resource may not always be used by a UE if the PUCCH reliability is high (or sufficiently high).

In some aspects, different UEs may be configured with different Orthogonal Cover Codes (OCC) for PUCCH transmission in the supplementary PUCCH resource. This may help distinguish different UEs transmitting on the same supplementary PUCCH resource. This may be especially useful and preferred for coherent (e.g., DMRS-based) PUCCH transmission.

In some aspects, different UEs may be configured with non-overlapping PUCCH sequences for PUCCH transmission in the supplementary PUCCH resource. This may be especially useful and preferred for non-coherent (e.g., sequence-based) PUCCH transmission.

Utilization of the techniques disclosed herein may enhance PUCCH reliability, decreasing the PDSCH discard rate and resulting in improved downlink throughput and resource efficiency.

### Example Operations

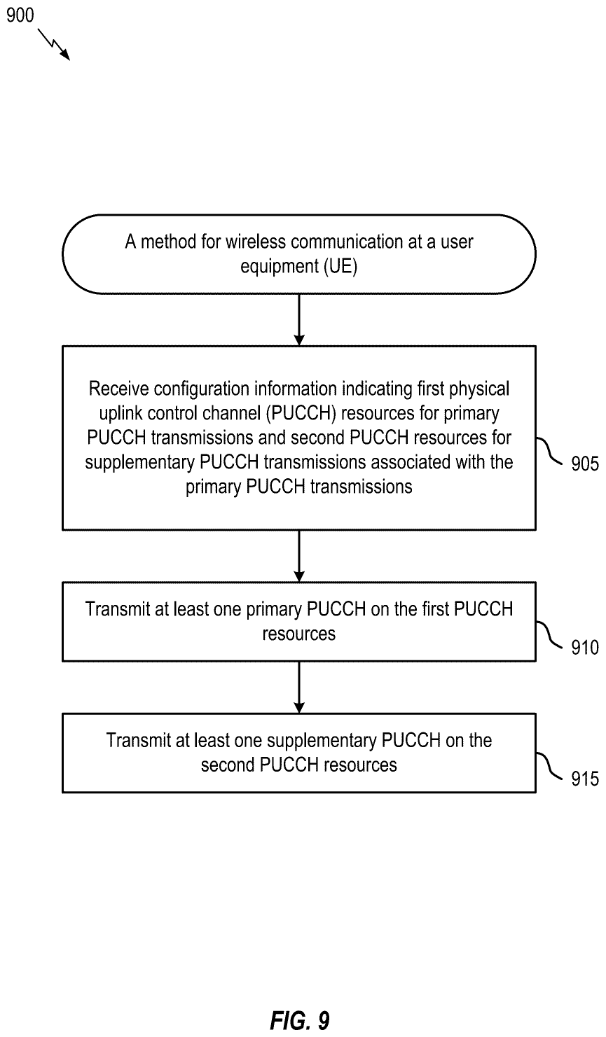

FIG. 9 shows an example of a method 900 of wireless communication at a user equipment (UE), such as a UE 104 of FIGS. 1 and 3.

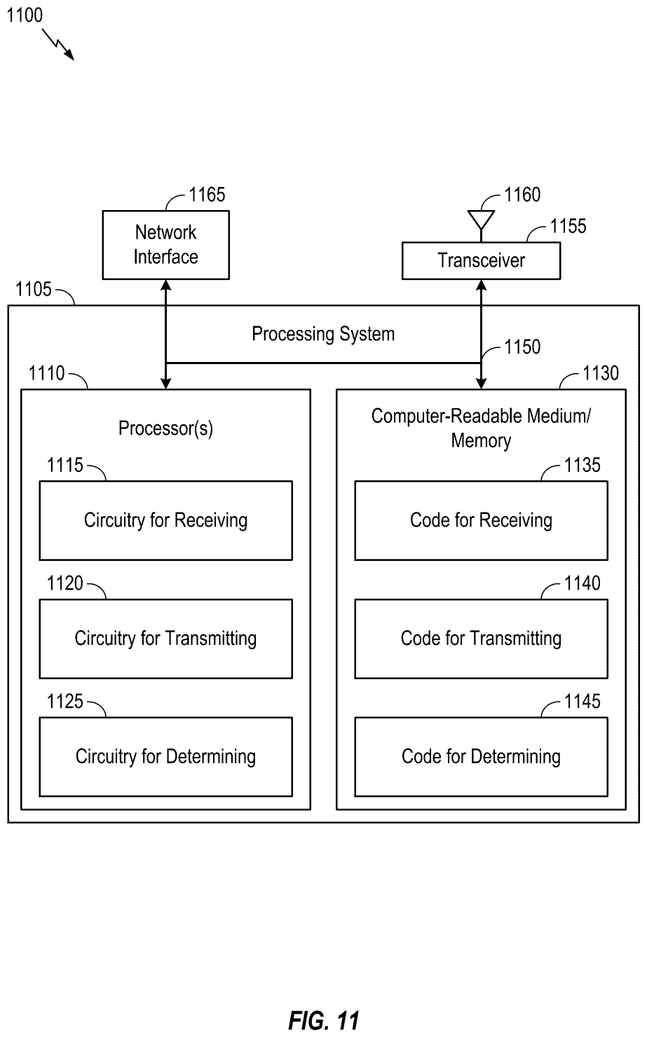

Method 900 begins at step 905 with receiving configuration information indicating first physical uplink control channel (PUCCH) resources for primary PUCCH transmissions and second PUCCH resources for supplementary PUCCH transmissions associated with the primary PUCCH transmissions. In some cases, the operations of this step refer to, or may be performed by, circuitry for receiving and/or code for receiving as described with reference to FIG. 11.

Method 900 then proceeds to step 910 with transmitting at least one primary PUCCH on the first PUCCH resources. In some cases, the operations of this step refer to, or may be performed by, circuitry for transmitting and/or code for transmitting as described with reference to FIG. 11.

Method 900 then proceeds to step 915 with transmitting at least one supplementary PUCCH on the second PUCCH resources. In some cases, the operations of this step refer to, or may be performed by, circuitry for transmitting and/or code for transmitting as described with reference to FIG. 11.

In some aspects, the method 900 further includes receiving signaling activating supplementary PUCCH transmission in the second PUCCH resources, wherein the at least one supplementary PUCCH is transmitted after receiving the signaling. In some cases, the operations of this step refer to, or may be performed by, circuitry for receiving and/or code for receiving as described with reference to FIG. 11.

In some aspects, the method 900 further includes receiving signaling deactivating supplementary PUCCH transmission in the second PUCCH resources, wherein the at least one supplementary PUCCH is transmitted before receiving the signaling. In some cases, the operations of this step refer to, or may be performed by, circuitry for receiving and/or code for receiving as described with reference to FIG. 11.

In some aspects, the second PUCCH resources comprise group-common resources allocated for one or more UEs including the UE.

In some aspects, the primary PUCCH transmission is of a first PUCCH format; and the supplementary PUCCH transmission is of a second PUCCH format different than the first PUCCH format.

In some aspects, the primary PUCCH is transmitted using a first PUCCH transmission scheme; and the supplementary PUCCH is transmitted using a second PUCCH transmission scheme different than the first PUCCH transmission scheme.

In some aspects, the configuration information comprises an information element (IE) that semi-persistently configures the first PUCCH resources and the second PUCCH resources.

In some aspects, the configuration information configures a first plurality of first PUCCH resources and a second plurality of second PUCCH resources; and the method further comprises receiving signaling dynamically selecting a first resource from the first plurality of first PUCCH resources, and a second resource from the second plurality of second PUCCH resources.

In some aspects, the primary PUCCH is transmitted in the selected first resource, and the supplementary PUCCH is transmitted in the selected second resource.

In some aspects, the first PUCCH resources are configured by first signaling, and the second PUCCH resources are configured by second signaling separately from the first signaling, wherein the second signaling indicates an association between the second PUCCH resources and the first PUCCH resources.

In some aspects, the method 900 further includes determining to transmit the supplementary PUCCH in the second PUCCH resources based on at least one of: a physical downlink shared channel (PDSCH) discard rate, a radio link control (RLC) acknowledge mode (AM) automatic repeat request (ARQ) rate, whether the supplementary PUCCH transmission includes a cyclic redundancy check (CRC), an uplink control information (UCI) type associated with the supplementary PUCCH transmission, or a payload size of the supplementary PUCCH transmission. In some cases, the operations of this step refer to, or may be performed by, circuitry for determining and/or code for determining as described with reference to FIG. 11.

In some aspects, a same uplink control information (UCI) payload is transmitted in the primary PUCCH and in the supplementary PUCCH.

In some aspects, a first portion of an uplink control information (UCI) payload is transmitted in the primary PUCCH; and a second portion of the UCI payload is transmitted in the supplementary PUCCH.

In some aspects, the primary PUCCH includes an indication that the supplementary PUCCH is transmitted or is to be transmitted in the second PUCCH resources.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

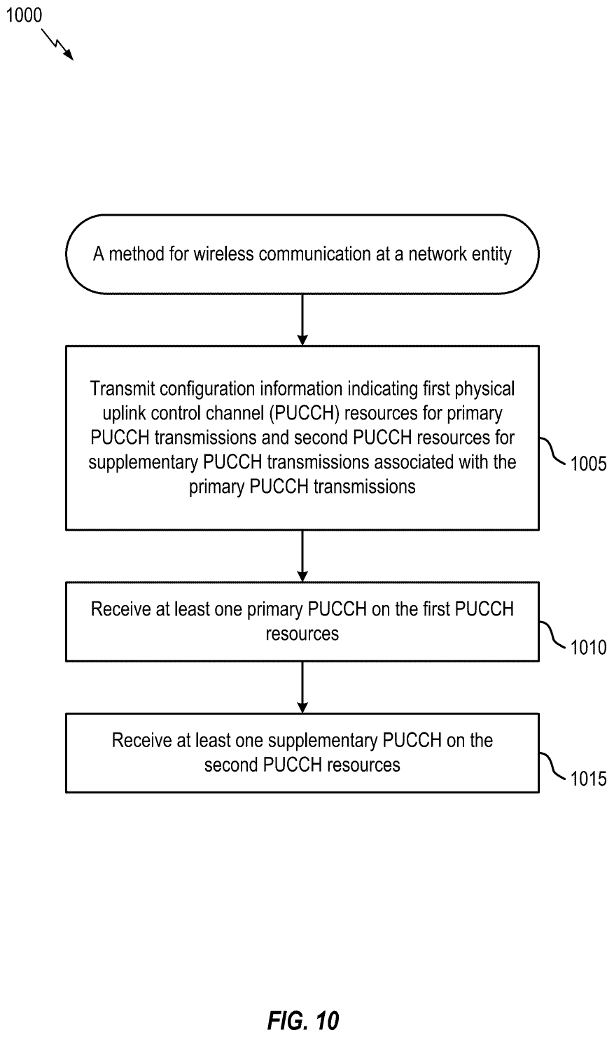

FIG. 10 shows an example of a method 1000 of wireless communication at a network entity, such as a BS 102 of FIGS. 1 and 3, or a disaggregated base station as discussed with respect to FIG. 2.

Method 1000 begins at step 1005 with transmitting configuration information indicating first physical uplink control channel (PUCCH) resources for primary PUCCH transmissions and second PUCCH resources for supplementary PUCCH transmissions associated with the primary PUCCH transmissions. In some cases, the operations of this step refer to, or may be performed by, circuitry for transmitting and/or code for transmitting as described with reference to FIG. 11.

Method 1000 then proceeds to step 1010 with receiving at least one primary PUCCH on the first PUCCH resources. In some cases, the operations of this step refer to, or may be performed by, circuitry for receiving and/or code for receiving as described with reference to FIG. 11.

Method 1000 then proceeds to step 1015 with receiving at least one supplementary PUCCH on the second PUCCH resources. In some cases, the operations of this step refer to, or may be performed by, circuitry for receiving and/or code for receiving as described with reference to FIG. 11.

In some aspects, the method 1000 further includes transmitting signaling activating supplementary PUCCH transmission in the second PUCCH resources, wherein the at least one supplementary PUCCH is received after transmitting the signaling. In some cases, the operations of this step refer to, or may be performed by, circuitry for transmitting and/or code for transmitting as described with reference to FIG. 11.

In some aspects, the method 1000 further includes transmitting signaling deactivating supplementary PUCCH transmission in the second PUCCH resources, wherein the at least one supplementary PUCCH is received before transmitting the signaling. In some cases, the operations of this step refer to, or may be performed by, circuitry for transmitting and/or code for transmitting as described with reference to FIG. 11.

In some aspects, the second PUCCH resources comprise group-common resources allocated for one or more UEs.

In some aspects, the primary PUCCH transmission is of a first PUCCH format; and the supplementary PUCCH transmission is of a second PUCCH format different than the first PUCCH format.

In some aspects, the configuration information comprises an information element (IE) that semi-persistently configures the first PUCCH resources and the second PUCCH resources.

In some aspects, the configuration information configures a first plurality of first PUCCH resources and a second plurality of second PUCCH resources; and the method further comprises transmitting signaling dynamically selecting a first resource from the first plurality of first PUCCH resources, and a second resource from the second plurality of second PUCCH resources.

In some aspects, the primary PUCCH is received in the selected first resource, and the supplementary PUCCH is received in the selected second resource.

In some aspects, the first PUCCH resources are configured by first signaling, and the second PUCCH resources are configured by second signaling separately from the first signaling, wherein the second signaling indicates an association between the second PUCCH resources and the first PUCCH resources.

In some aspects, a same uplink control information (UCI) payload is received in the primary PUCCH and in the supplementary PUCCH.

In some aspects, a first portion of an uplink control information (UCI) payload is received in the primary PUCCH; and a second portion of the UCI payload is received in the supplementary PUCCH.

In some aspects, the primary PUCCH includes an indication that the supplementary PUCCH is transmitted or is to be transmitted in the second PUCCH resources.

In some aspects, the method 1000 further includes receiving, from a UE, a quantity of consecutive supplementary PUCCH transmissions in the second PUCCH resources. In some cases, the operations of this step refer to, or may be performed by, circuitry for receiving and/or code for receiving as described with reference to FIG. 11.

In some aspects, the method 1000 further includes transmitting, based on the quantity being greater than a threshold, signaling indicating a PUCCH format to be used by the UE for subsequent supplementary PUCCH transmissions. In some cases, the operations of this step refer to, or may be performed by, circuitry for transmitting and/or code for transmitting as described with reference to FIG. 11.

In some aspects, the configuration information configures a plurality of UEs to use the second PUCCH resources for supplementary PUCCH transmissions.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3. In some aspects, communications device 1100 is a network entity, such as BS 102 of FIGS. 1 and 3, or a disaggregated base station as discussed with respect to FIG. 2.

The communications device 1100 includes a processing system 1105 coupled to the transceiver 1155 (e.g., a transmitter and/or a receiver). In some aspects (e.g., when communications device 1100 is a network entity), processing system 1105 may be coupled to a network interface 1165 that is configured to obtain and send signals for the communications device 1100 via communication link(s), such as a backhaul link, midhaul link, and/or fronthaul link as described herein, such as with respect to FIG. 2. The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it; and the method 1000 described with respect to FIG. 10, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for receiving 1135, code for transmitting 1140, and code for determining 1145. Processing of the code for receiving 1135, code for transmitting 1140, and code for determining 1145 may cause the communications device 1100 to perform the method 900 described with respect to FIG. 9, or any aspect related to it; and the method 1000 described with respect to FIG. 10, or any aspect related to it.

The one or more processors 1110 include circuitry configured to implement (e.g., execute) the code stored in the computer-readable medium/memory 1130, including circuitry for receiving 1115, circuitry for transmitting 1120, and circuitry for determining 1125. Processing with circuitry for receiving 1115, circuitry for transmitting 1120, and circuitry for determining 1125 may cause the communications device 1100 to perform the method 900 described with respect to FIG. 9, or any aspect related to it; and the method 1000 described with respect to FIG. 10, or any aspect related to it.

Various components of the communications device 1100 may provide means for performing the method 900 described with respect to FIG. 9, or any aspect related to it; and the method 1000 described with respect to FIG. 10, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1155 and the antenna 1160 of the communications device 1100 in FIG. 11. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1155 and the antenna 1160 of the communications device 1100 in FIG. 11.

### Example Clauses

Implementation examples are described in the following numbered clauses:

Clause 1: A method for wireless communication at a user equipment (UE), comprising: receiving configuration information indicating first physical uplink control channel (PUCCH) resources for primary PUCCH transmissions and second PUCCH resources for supplementary PUCCH transmissions associated with the primary PUCCH transmissions; transmitting at least one primary PUCCH on the first PUCCH resources; and transmitting at least one supplementary PUCCH on the second PUCCH resources.

Clause 2: The method of Clause 1, further comprising: receiving signaling activating supplementary PUCCH transmission in the second PUCCH resources, wherein the at least one supplementary PUCCH is transmitted after receiving the signaling.

Clause 3: The method of any one of Clauses 1-2, further comprising: receiving signaling deactivating supplementary PUCCH transmission in the second PUCCH resources, wherein the at least one supplementary PUCCH is transmitted before receiving the signaling.

Clause 4: The method of any one of Clauses 1-3, wherein the second PUCCH resources comprise group-common resources allocated for one or more UEs including the UE.

Clause 5: The method of any one of Clauses 1-4, wherein: the primary PUCCH transmission is of a first PUCCH format; and the supplementary PUCCH transmission is of a second PUCCH format different than the first PUCCH format.

Clause 6: The method of any one of Clauses 1-5, wherein: the primary PUCCH is transmitted using a first PUCCH transmission scheme; and the supplementary PUCCH is transmitted using a second PUCCH transmission scheme different than the first PUCCH transmission scheme.

Clause 7: The method of any one of Clauses 1-6, wherein the configuration information comprises an information element (IE) that semi-persistently configures the first PUCCH resources and the second PUCCH resources.

Clause 8: The method of any one of Clauses 1-7, wherein: the configuration information configures a first plurality of first PUCCH resources and a second plurality of second PUCCH resources; and the method further comprises receiving signaling dynamically selecting a first resource from the first plurality of first PUCCH resources, and a second resource from the second plurality of second PUCCH resources.

Clause 9: The method of Clause 8, wherein: the primary PUCCH is transmitted in the selected first resource, and the supplementary PUCCH is transmitted in the selected second resource.

Clause 10: The method of any one of Clauses 1-9, wherein: the first PUCCH resources are configured by first signaling, and the second PUCCH resources are configured by second signaling separately from the first signaling, wherein the second signaling indicates an association between the second PUCCH resources and the first PUCCH resources.

Clause 11: The method of any one of Clauses 1-10, further comprising determining to transmit the supplementary PUCCH in the second PUCCH resources based on at least one of: a physical downlink shared channel (PDSCH) discard rate, a radio link control (RLC) acknowledge mode (AM) automatic repeat request (ARQ) rate, whether the supplementary PUCCH transmission includes a cyclic redundancy check (CRC), an uplink control information (UCI) type associated with the supplementary PUCCH transmission, or a payload size of the supplementary PUCCH transmission.

Clause 12: The method of any one of Clauses 1-11, wherein a same uplink control information (UCI) payload is transmitted in the primary PUCCH and in the supplementary PUCCH.

Clause 13: The method of any one of Clauses 1-12, wherein: a first portion of an uplink control information (UCI) payload is transmitted in the primary PUCCH; and a second portion of the UCI payload is transmitted in the supplementary PUCCH.

Clause 14: The method of any one of Clauses 1-13, wherein the primary PUCCH includes an indication that the supplementary PUCCH is transmitted or is to be transmitted in the second PUCCH resources.

Clause 15: A method for wireless communication at a network entity, comprising: transmitting configuration information indicating first physical uplink control channel (PUCCH) resources for primary PUCCH transmissions and second PUCCH resources for supplementary PUCCH transmissions associated with the primary PUCCH transmissions; receiving at least one primary PUCCH on the first PUCCH resources; and receiving at least one supplementary PUCCH on the second PUCCH resources.

Clause 16: The method of Clause 15, further comprising: transmitting signaling activating supplementary PUCCH transmission in the second PUCCH resources, wherein the at least one supplementary PUCCH is received after transmitting the signaling.

Clause 17: The method of any one of Clauses 15-16, further comprising: transmitting signaling deactivating supplementary PUCCH transmission in the second PUCCH resources, wherein the at least one supplementary PUCCH is received before transmitting the signaling.

Clause 18: The method of any one of Clauses 15-17, wherein the second PUCCH resources comprise group-common resources allocated for one or more UEs.

Clause 19: The method of any one of Clauses 15-18, wherein: the primary PUCCH transmission is of a first PUCCH format; and the supplementary PUCCH transmission is of a second PUCCH format different than the first PUCCH format.

Clause 20: The method of any one of Clauses 15-19, wherein the configuration information comprises an information element (IE) that semi-persistently configures the first PUCCH resources and the second PUCCH resources.

Clause 21: The method of any one of Clauses 15-20, wherein: the configuration information configures a first plurality of first PUCCH resources and a second plurality of second PUCCH resources; and the method further comprises transmitting signaling dynamically selecting a first resource from the first plurality of first PUCCH resources, and a second resource from the second plurality of second PUCCH resources.

Clause 22: The method of Clause 21, wherein: the primary PUCCH is received in the selected first resource, and the supplementary PUCCH is received in the selected second resource.

Clause 23: The method of any one of Clauses 15-22, wherein: the first PUCCH resources are configured by first signaling, and the second PUCCH resources are configured by second signaling separately from the first signaling, wherein the second signaling indicates an association between the second PUCCH resources and the first PUCCH resources.

Clause 24: The method of any one of Clauses 15-23, wherein a same uplink control information (UCI) payload is received in the primary PUCCH and in the supplementary PUCCH.

Clause 25: The method of any one of Clauses 15-24, wherein: a first portion of an uplink control information (UCI) payload is received in the primary PUCCH; and a second portion of the UCI payload is received in the supplementary PUCCH.

Clause 26: The method of any one of Clauses 15-25, wherein the primary PUCCH includes an indication that the supplementary PUCCH is transmitted or is to be transmitted in the second PUCCH resources.

Clause 27: The method of any one of Clauses 15-26, further comprising: receiving, from a UE, a quantity of consecutive supplementary PUCCH transmissions in the second PUCCH resources; and transmitting, based on the quantity being greater than a threshold, signaling indicating a PUCCH format to be used by the UE for subsequent supplementary PUCCH transmissions.

Clause 28: The method of any one of Clauses 15-27, wherein the configuration information configures a plurality of UEs to use the second PUCCH resources for supplementary PUCCH transmissions.

Clause 29: An apparatus, comprising: at least one memory comprising executable instructions; and at least one processor configured to execute the executable instructions and cause the apparatus to perform a method in accordance with any combination of Clauses 1-28.

Clause 30: An apparatus, comprising means for performing a method in accordance with any combination of Clauses 1-28.

Clause 31: A non-transitory computer-readable medium comprising executable instructions that, when executed by at least one processor of an apparatus, cause the apparatus to perform a method in accordance with any combination of Clauses 1-28.

Clause 32: A computer program product embodied on a computer-readable storage medium comprising code for performing a method in accordance with any combination of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for transmitting, and means for determining may comprise one or more processors, such as one or more of the processors described above with reference to FIG. 11.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive configuration information indicating first physical uplink control channel (PUCCH) resources for primary PUCCH transmissions and second PUCCH resources for supplementary PUCCH transmissions associated with the primary PUCCH transmissions;
transmit at least one primary PUCCH on the first PUCCH resources; and
transmit at least one supplementary PUCCH on the second PUCCH resources.

2. The apparatus of claim 1, wherein the UE decides to transmit the at least one supplementary PUCCH on the second PUCCH resources, when at least one condition is met that indicates the at least one primary PUCCH was not successfully received.

3. The apparatus of claim 1, wherein the one or more processors are further configured to cause the apparatus to:
receive signaling activating supplementary PUCCH transmission in the second PUCCH resources, wherein the at least one supplementary PUCCH is transmitted after receiving the signaling.

4. The apparatus of claim 1, wherein the one or more processors are further configured to cause the apparatus to:
receive signaling deactivating supplementary PUCCH transmission in the second PUCCH resources, wherein the at least one supplementary PUCCH is transmitted before receiving the signaling.

5. The apparatus of claim 1, wherein the second PUCCH resources comprise group-common resources allocated for one or more UEs including the UE.

6. The apparatus of claim 1, wherein:
the primary PUCCH transmission is of a first PUCCH format; and
the supplementary PUCCH transmission is of a second PUCCH format different than the first PUCCH format.

7. The apparatus of claim 1, wherein:
the primary PUCCH is transmitted using a first PUCCH transmission scheme; and
the supplementary PUCCH is transmitted using a second PUCCH transmission scheme different than the first PUCCH transmission scheme.

8. The apparatus of claim 1, wherein the configuration information comprises an information element (IE) that semi-persistently configures the first PUCCH resources and the second PUCCH resources.

9. The apparatus of claim 1, wherein:
the configuration information configures a first plurality of first PUCCH resources and a second plurality of second PUCCH resources; and
the one or more processors are further configured to cause the apparatus to: receive signaling dynamically selecting:
the first resource from the first plurality of first PUCCH resources, and
the second resource from the second plurality of second PUCCH resources.

10. The apparatus of claim 1, wherein:
the first PUCCH resources are configured by first signaling, and
the second PUCCH resources are configured by second signaling separately from the first signaling, wherein the second signaling indicates an association between the second PUCCH resources and the first PUCCH resources.

11. The apparatus of claim 1, wherein the at least one condition involves at least one of:
a physical downlink shared channel (PDSCH) discard rate,
a radio link control (RLC) acknowledge mode (AM) automatic repeat request (ARQ) rate,
whether the supplementary PUCCH transmission includes a cyclic redundancy check (CRC),
an uplink control information (UCI) type associated with the supplementary PUCCH transmission, or
a payload size of the supplementary PUCCH transmission.

12. The apparatus of claim 1, wherein a same uplink control information (UCI) payload is transmitted in the primary PUCCH and in the supplementary PUCCH.

13. The apparatus of claim 1, wherein:
a first portion of an uplink control information (UCI) payload is transmitted in the primary PUCCH; and
a second portion of the UCI payload is transmitted in the supplementary PUCCH.

14. The apparatus of claim 1, wherein the primary PUCCH includes an indication that the supplementary PUCCH is transmitted or is to be transmitted in the second PUCCH resources.

15. An apparatus for wireless communication at a network entity, comprising:
at least one memory comprising computer-executable instructions; and
one or more processors configured to execute the computer-executable instructions and cause the apparatus to:
transmit configuration information indicating first physical uplink control channel (PUCCH) resources for primary PUCCH transmissions and second PUCCH resources for supplementary PUCCH transmissions associated with the primary PUCCH transmissions;
receive at least one primary PUCCH on the first PUCCH resources; and
receive at least one supplementary PUCCH on the second PUCCH resources.

16. The apparatus of claim 1, wherein configuration information configures the UE to transmit the at least one supplementary PUCCH on the second PUCCH resources, when at least one condition is met that indicates a primary PUCCH on the first PUCCH resources was not successfully received.

17. The apparatus of claim 15, wherein the one or more processors are further configured to cause the apparatus to:
transmit signaling activating supplementary PUCCH transmission in the second PUCCH resources, wherein the at least one supplementary PUCCH is received after transmitting the signaling.

18. The apparatus of claim 15, wherein the one or more processors are further configured to cause the apparatus to:
transmit signaling deactivating supplementary PUCCH transmission in the second PUCCH resources, wherein the at least one supplementary PUCCH is received before transmitting the signaling.

19. The apparatus of claim 15, wherein the second PUCCH resources comprise group-common resources allocated for one or more UEs.

20. The apparatus of claim 15, wherein:
the primary PUCCH transmission is of a first PUCCH format; and
the supplementary PUCCH transmission is of a second PUCCH format different than the first PUCCH format.

21. The apparatus of claim 15, wherein the configuration information comprises an information element (IE) that semi-persistently configures the first PUCCH resources and the second PUCCH resources.

22. The apparatus of claim 15, wherein:
the configuration information configures a first plurality of first PUCCH resources and a second plurality of second PUCCH resources; and
the one or more processors are further configured to cause the apparatus to transmit signaling dynamically selecting a first resource from the first plurality of first PUCCH resources, and a second resource from the second plurality of second PUCCH resources.

23. The apparatus of claim 22, wherein:
the primary PUCCH is received in the selected first resource, and
the supplementary PUCCH is received in the selected second resource.

24. The apparatus of claim 15, wherein:
the first PUCCH resources are configured by first signaling, and
the second PUCCH resources are configured by second signaling separately from the first signaling, wherein the second signaling indicates an association between the second PUCCH resources and the first PUCCH resources.

25. The apparatus of claim 15, wherein a same uplink control information (UCI) payload is received in the primary PUCCH and in the supplementary PUCCH.

26. The apparatus of claim 15, wherein:
a first portion of an uplink control information (UCI) payload is received in the primary PUCCH; and
a second portion of the UCI payload is received in the supplementary PUCCH.

27. The apparatus of claim 15, wherein the primary PUCCH includes an indication that the supplementary PUCCH is transmitted or is to be transmitted in the second PUCCH resources.

28. The apparatus of claim 15, wherein the one or more processors are further configured to cause the apparatus to:
receive, from a UE, a quantity of consecutive supplementary PUCCH transmissions in the second PUCCH resources; and
transmit, based on the quantity being greater than a threshold, signaling indicating a PUCCH format to be used by the UE for subsequent supplementary PUCCH transmissions.

29. A method for wireless communication at a user equipment (UE), comprising:
receiving configuration information indicating first physical uplink control channel (PUCCH) resources for primary PUCCH transmissions and second PUCCH resources for supplementary PUCCH transmissions associated with the primary PUCCH transmissions;
transmitting at least one primary PUCCH on the first PUCCH resources; and
transmitting at least one supplementary PUCCH on the second PUCCH resources.

30. A method for wireless communication at a network entity, comprising:
transmitting configuration information indicating first physical uplink control channel (PUCCH) resources for primary PUCCH transmissions and second PUCCH resources for supplementary PUCCH transmissions associated with the primary PUCCH transmissions;
receiving at least one primary PUCCH on the first PUCCH resources; and
receiving at least one supplementary PUCCH on the second PUCCH resources.
